(19) United States
(12) Patent Application Publication
(10) Pub. No.: US 2009/0164068 A1
(43) Pub. Date: Jun. 25, 2009

(54) Vehicle behavior control device

(76) Inventor: Hiroyuki Tamai, Kanagawa (JP)

Correspondence Address: JACOBSON HOLMAN PLLC, 400 SEVENTH STREET N.W., SUITE 600, WASHINGTON, DC, 20004, US

(21) Appl. No.: 12/314,094

(22) Filed: Dec. 3, 2008

(30) Foreign Application Priority Data
Dec. 20, 2007 (JP) 2007-328646

(51) Int. Cl. G06F 7/00

(52) U.S. Cl. 701/42

(57) ABSTRACT

A vehicle behavior control device to control a yawing movement of a vehicle during a circling movement thereof, the device comprising a control start decision means 38 that starts a vehicle behavior control by starting a control as to a braking force difference between vehicle wheels when a value of a yaw angular velocity deviation Δγ that is a deviation between a command yaw angular velocity and an actual yaw angular velocity, and a value of a steering wheel angular velocity θv exceed a prescribed standard thresholds;

wherein the control start decision means 38 starts or stops the control as to the braking force difference by determining whether a threshold is greater or smaller than a standard threshold when the yaw angular velocity deviation Δ is estimated as being on the increase or decrease based on the steering wheel angular velocity θv.

### BACKGROUND OF THE INVENTION

1. Field of the Invention

The present invention relates to a vehicle behavior control device and a method thereof, whereby a yawing movement during a transient turning movement of the vehicle is stabilized with a yawing altitude control concerning the vehicle, preferably with the vehicle behavior control by means of an automated brake, whereby the execution timing of the control is adjusted so as to be started and stopped pertinently.

2. Description of the Related Art

A patent reference 1 (JP1998-273028) or a patent reference 2 (JP3303435), for instance, discloses a vehicle steering control device to control a vehicle turning movement in a manner that a braking force difference between a prescribed pair of wheels is given, while the vehicle is being steered.

In the technology of the patent reference 1, a command (i.e. a target) yaw angular velocity is calculated based upon a vehicle speed and a steering wheel angular velocity that is computed through steering wheel angular displacements as to front wheels; a deviation between the command yaw angular velocity and an actual yaw angular velocity is made comparison with a criterion, namely, a threshold to determine the commencement of the yawing altitude control; and, in case when the yaw angular velocity passes the threshold, a yaw moment control is started.

A vehicle steering behavior control device according to the patent reference 1 comprises:

an actual steering condition grasp means to grasp an actual steering condition;

a driving/braking force distribution control means to control a driving force distribution and/or a braking force distribution over the wheels of the vehicle so that an actual steering condition responds to a command steering condition in case when a deviation between both the conditions exceeds a criterion;

a controllability margin detection means to detect a controllability margin of the driving/braking force distribution control means over the actually operated steering condition, whereby the controllability margin corresponds to steering operation easiness with which a driver thinks he or she can handle the vehicle; and

a control start criterion determination means to adjust the control start criterion so that a surplus of the controllability margin can be evaded.

Thus, the patent reference 2 discloses a technology as to when a driving/braking force distribution control is started under the condition that the deviation between the actual and command steering conditions during a steering movement reaches the criterion; further, in the technology, a criterion as to whether the control is to be started or not can be altered in accordance with the level of the controllability margin that corresponds to steering operation easiness with which a driver thinks he or she can handle the vehicle.

Furthermore, the reference 2 discloses, in relation to the control of driving/braking force distribution between left/right wheels, that a driving/braking force difference ΔB between right wheels and left wheels is calculated with the following equation (1); in addition, the driving/braking force distribution control is executed when the absolute value of ΔB exceeds a threshold H, and the value H is calculated on a basis of running conditions of the vehicle and the controllability margin as to the driver's steering operation easiness.

ΔB=K(γ_{ref}−γ) (1)

where γ_{ref}, γ, and K denote a command yaw angular velocity, an actual yaw angular velocity, and a control gain respectively.

Further, the reference 2 discloses the following equation (2) with which the threshold H is calculated as a function of reference parameters H1 to H5.

H=f(H1,H2,H3,H4,H5) (2)

where H1, H2, H3, H4, and H5 denote a vehicle speed, a steering wheel angular displacement, an opening level of the gas pedal, a depressing force on the brake pedal, and an absolute value of a steering wheel angular velocity respectively.

Hereby, it is noted that a notation abs(x) is frequently used later in this specification so as to express an absolute value of a variable x.

On the other hand, in the reference 1, a criterion for determining a control start condition, namely, a threshold is a constant value; as a result, steering operation easiness for a driver is not always achieved. Further, the reference 2 discloses that a threshold H as a control start criterion is calculated on a basis of running conditions of the vehicle and the controllability margin as to a driver's steering operation easiness, especially with reference to an absolute value H5 of a steering wheel angular velocity; however, the criterion is based on only an absolute value H5 of a steering wheel angular velocity and the criterion does not reflect a steering direction as to whether the velocity is on the increase or on the decrease. In other words, it is out of consideration whether the yaw angular velocity deviation is on the increase or on the decrease; thus, the manner in the reference 2 is not sufficient to reflect a controllability margin as to a driver's steering operation easiness. It is pertinent to judge that the controllability margin is little, while the yaw angular velocity deviation is being on the increase; and, the margin is secured well in moderation, while the deviation is being on the decrease. There is not such a consideration in the references; that is, with the conventional approaches, it is difficult to accurately reflect a driver's intention in relation to a vehicle steering movement, even based on a concept of a controllability margin.

When the control start timing is hastened only with a small threshold as to the control start, then, there arises a possibility that is neither desired nor expected by a driver in such a manner that the vehicle behavior control intervenes in a manual operation. In case of such a possibility, it is afraid that the control fails to conform to manual operations.

Contrary to the above, when the control start timing is delayed with an excessive threshold, then, the control starts after a pertinent timing; thus, there arise other undesirable possibilities such as strong under-steering and/or strong over-steering.

Hereafter, the present invention will be disclosed in consideration of the above-described backgrounds. The subjects of the invention are to provide a vehicle behavior control device and a method thereof, whereby the yawing movement during a transient turning movement of a vehicle is improved in responsiveness and stability, namely, in quick response and stable convergence, so that a yawing control is performed with an automatic control commencement or termination so as to accurately reflect a driver's intention in relation to a vehicle steering movement; that is, a strong under-steering or over-steering condition can be evaded.

### SUMMARY OF THE INVENTION

In order to settle the above described subjects, the present invention discloses a vehicle behavior control device for controlling a yawing movement of a vehicle during a circling movement by giving a braking force difference between a right wheel and a left wheel to prescribed wheels, wherein the device comprises:

a wheel velocity detection means;

a steering wheel angular displacement detection means to detect a steering wheel angular displacement;

a yaw angular velocity detection means to detect an actual yaw angular velocity;

a command yaw angular velocity calculation means to calculate a command yaw angular velocity based upon a wheel velocity retrieved by the wheel velocity detection means and a steering wheel angular displacement retrieved by the steering wheel angular displacement detection means;

a yaw angular velocity deviation calculation means to calculate a yaw angular velocity deviation between a command yaw angular velocity calculated by the command yaw angular velocity calculation means and an actual yaw angular velocity detected by the yaw angular velocity detection means;

a steering evaluation means to estimate whether the yaw angular velocity deviation is on the increase or on the decrease;

a control start decision means to determine whether a control as to the braking force difference between the wheels is started or not when the yaw angular velocity deviation calculated by the yaw angular velocity deviation calculation means pass a prescribed threshold;

whereby, the prescribed threshold is altered when it is estimated whether the yaw angular velocity deviation is on the increase or on the decrease.

According to the present invention, the yawing movement during a transient turning movement of a vehicle is improved in responsiveness and stability, namely, in quick response and stable convergence, so that a yawing control is performed with an automatic control commencement or termination so as to accurately reflect a driver's intention in relation to a vehicle steering movement; thus, a strong under-steering or over-steering condition can be evaded. The present invention provides such a vehicle behavior control device and a method thereof so as to realize the above-mentioned functions.

### BRIEF DESCRIPTION OF THE DRAWINGS

The present invention will now be described in greater detail with reference to the preferred embodiments of the invention and the accompanying drawings, wherein:

FIG. 1 shows a block diagram that shows the whole structure as to the vehicle behavior control device according the present invention;

FIG. 2 shows a control flow chart by means of the control means according the present invention;

FIG. 3 explains a threshold zone map in a 2-dimensional expression;

FIG. 4 shows an example of a transient change as to a steering wheel angular displacement and a steering wheel angular velocity during a lane change;

FIG. 5 explains a vehicle behavior during the lane change in case of a vehicle without the vehicle behavior control device; and

FIG. 6 shows an example of a transient change as to a yaw angular velocity deviation Δγ and a steering wheel angular velocity θᵥ during the lane change in case of a vehicle without the vehicle behavior control device.

### DETAILED DESCRIPTION OF THE PREFERRED EMBODIMENTS INVENTION

Hereafter, the present invention will be described in detail with reference to the embodiments shown in the figures. However, the dimensions, materials, shape, the relative placement and so on of a component described in these embodiments shall not be construed as limiting the scope of the invention thereto, unless especially specific mention is placed.

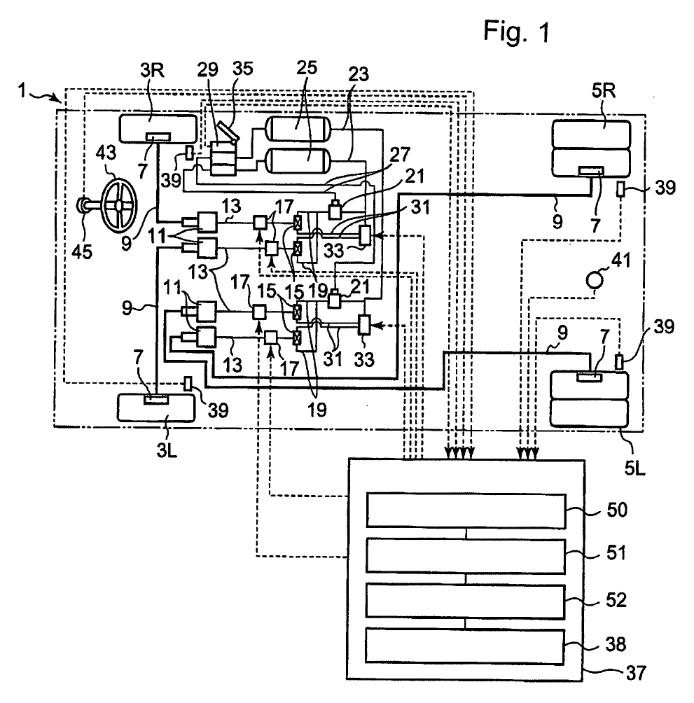

At first, with reference to FIG. 1, outline structure of a vehicle brake system to which the present invention is applied is explained.

A vehicle 1 is a large vehicle such as a truck, a bus, a trailer, or the like provided with front wheels 3R and 3L for steering as well as with rear wheels 5R and 5L for driving.

The brake system for the vehicle comprises an air-over-hydraulic brake that actuates a hydraulic brake using air pressure.

More specifically, each of the wheels 3R, 3L, 5R, and 5L is provided with a wheel cylinder 7 that is operated by a supply of braking pressure, i.e. hydraulic pressure. Each of the wheel cylinders 7 is connected to an oil pressure tube 9 to which an air-over-hydraulic booster 11 for converting air pressure to the hydraulic pressure is connected. Each air over-hydraulic booster 11 is communicated to an outlet port of a two-way check valve 15 via an air pressure pipe 13 having a pressure control valve 17 therein.

To a first inlet port of each two-way check valve 15, is connected respectively an air supply pipe 19 that communicates the first inlet port with a relay valve 21. To be more specific, the two air supply pipes 19 for the front wheels 3R and 3L are connected to a first relay valve 21, and other two air supply pipes 19 for the rear wheels 5R and 5L are connected to a second relay valve 21.

Further, from each one of relay valves 21, an air charge pipe 23 is extended toward and connected to a corresponding air bottle 25. To be more precise, the piping lines from the first inlet ports of the two-way check valves 15 for the front wheels 3R and 3L join into one piping line at one of the relay valves 21 so as to reach one of the air bottles 25; in a same way, the piping lines from the first inlet ports of the two-way check valves 15 for the rear wheels 5R and 5L join into one piping line at the other relay valve 21 so as to reach the other air bottle 25. In addition, air is supplied into the air bottles 25 from an air compressor (not shown) that is driven by the engine of the vehicle.

Furthermore, a signal pressure passage 27 is connected to an input port of each relay valve 21, whereby the signal pressure passage 27 connects the input port of each relay valve 21 to the corresponding air bottle 25 via a brake valve 29 of a dual type. Thus, the signal pressure line for the front wheels 3R and 3L are formed as a common line from the brake valve 29 toward the corresponding relay valve 21 via the signal pressure passage 27; so is the signal pressure line for the rear wheels 5R and 5L.

On the other hand, to a second inlet port of each two-way check valve 15, is connected respectively an air charge passage 31 that communicates the second inlet port of the two-way check valve 15 with an air charge valve 33, whereby there are four air charge passages 31, two for the front wheels connected to the first charge valve 33 and remaining two for the rear wheels connected to the second air charge valve 33. That is to say, one of the air charge pipes 23 for the rear wheels extending from one of the air bottles 25 branches into two pipes at the downstream side therein; one of the branched pipe is connected to the corresponding first relay valve 21 and the other branched pipe is connected to the corresponding one of the air charge valves 33. In a same way, the other air charge pipe 23 for the rear wheels extending from the another one of the air bottles 25 branches into two pipes at the downstream side of the air charge pipe 23; one of the branched pipes is connected to the second relay valve 21 and the other is connected to one of the air charge valves 33.

Thus, the air charge lines for the front wheels 3R and 3L, from the second inlet ports of the two-way check valves 15 toward one of the air bottles 25 via one of the air charge valves 33, comprise a common part on the line. In the same way, the air charge lines for the rear wheels 5R and 5L, from the second inlet ports of the two-way check valves 15 toward one of the air bottles 25 via the another one of the air charge valves 33, comprise a common part on the line.

A brake system of the vehicle 1 comprises a service brake circuit forming from the above-mentioned air-pressure lines, signal pressure lines, and oil pressure lines, and the brake system also comprises an automatic brake circuit forming from the above-mentioned air-pressure/air charge lines and oil pressure lines.

As it is publicly known, in an operation mode of the service brake circuit, when an operator presses on a brake pedal 35, a signal pressure in response to the pressing force and the pressing stroke is supplied to the inlet port of each relay valve 21. The relay valve 21 is opened according to the signal pressure, while opening angle of the valve is controlled based on the amount of the signal pressure; thus, a hydraulic pressure i.e. an air pressure is supplied to the air-over-hydraulic boosters 11 from the air bottles 25 through the air charge pipes 23, the air supply pipes 19, and the air pressure pipes 13.

Further, at the air-over-hydraulic boosters 11, the air pressure is converted into the oil pressure; thereby, with the set-up oil pressure, wheel cylinders 7 activate respective wheel-brakes (not shown) so as to generate braking forces on the front wheels 3R and 3L as well as the rear wheels 5R and 5L.

In addition, as a driver weakens the pressing force on the brake pedal 35 or reduces the pressing strokes thereon, the signal pressure supplied to the relay valves 21 are reduced accordingly, and as the driver entirely releases the pressing on the pedal, the pressure signal supply is fully stopped.

Thus, with such signal pressure reduction or shutdown, the air pressure supplied to the air-over-hydraulic boosters 11 through the relay valves 21 is reduced or stopped accordingly.

On the other hand, in an operation mode of the automatic brake circuit, braking force can be generated independently from the driver's braking operation; to be more precise, each air charge valve 33 comprises a valve unit (not shown) with two built-in solenoid valves both of which are a two-way solenoid operated directional valve, and the solenoid of each air charge valve 33 is connected to a control means 37 by which the automatic brake circuit is operated.

For simplicity, in FIG. 1, a connection between the control means 37 and the air charge valve 33 is depicted with a one-line signal wire; more exactly, each air charge valve 33 comprises an inlet port, two outlet ports (a first/second outlet port), and an exhaust port, whereby the above-mentioned air charge pipe 23 is connected to the inlet port. On the other hand, the air charge passages 31 that correspond to the front right wheel 3R and the rear right wheel 5R are connected to the mentioned first outlet ports of the air charge valves 33, while the air charge passages 31 that correspond to the front left wheel 3L and the rear left wheel 5L are connected to the mentioned second outlet ports of the air charge valves 33.

Further, out of the above-mentioned two solenoid-valves in each air charge valve 33, one corresponds to the first outlet port and the other corresponds to the second outlet port. When both of the solenoid valves in each air charge valve 33 are in an inactivate position, the inlet port of the air charge valve 33 is kept in closed condition; then, an air pressure inflow into each air charge valve 33 from the corresponding air charge pipe 23 is intercepted, while the two outlet ports are communicated with the exhaust port in each valve 33; thus, the inside of the air charge pipe 23 becomes open toward the atmosphere.

When, in the above-mentioned two solenoid-valves in each air charge valve 33, an operated direction is changed in response to an actuation signal from the control means 37, the inlet port is communicated with the two outlet port inside each air charge valve 33; then, the exhaust port is closed. Thus, an air pressure is supplied to an air-over-hydraulic booster 11 from the corresponding air bottle 25 through the air charge pipe 23 and the air pressure pipe 13. Thus, in an operation mode of the automatic brake circuit, wheel brake can be operated, as is the case in an operation mode of the service brake circuit.

Further, an air pressure from the air charge pipe 23 can be outputted to one of the right wheel pair or the left wheel pair, in a manner that the control means 37 activates one of the two solenoid valves in each air charge valve 33 that correspond to the right wheel pair or the left wheel pair. More specifically, an independent air pressures supply to each one of the four air-over-hydraulic boosters 11 corresponding to each of the wheels 3R, 3L, 5R, and 5L is possible.

Therefore, in an operation mode of the automatic brake circuit a brake force can be generated independently on each wheel 3R, 3L, 5R, or 5L regardless of the driver operation; that is, without the activation of the brake valve 29 through the brake pedal 35.

The pressure control valve 17 has three ports, i.e. an inlet port, an outlet port that is connected to the air-over-hydraulic booster 11 so that an air pressure is supplied thereto, and an exhaust port through which an air is discharged toward the atmosphere; further, the pressure control valve 17 comprises a first solenoid on-off valve that opens and closes the inlet port as well as a second solenoid on-off valve that opens and closes a communicating passage between the outlet port and the exhaust port.

Then, in response to a signal from the control means 37, the two solenoid-on-off valves in the pressure control valve 17 are controlled so as to perform on-off movements; thus, the pressure of the compressed air to be supplied to the air-over-hydraulic booster 11 is regulated.

As is described in the above, with an operation mode of the automatic brake circuits the control means 37 regulates the braking pressure of each wheel cylinder 7 for the wheels 3R, 3L, 5R, and 5L.

Hereafter, an explanation of the control means 37 that performs the above-mentioned control will be given.

In the control means 37, the signals are inputted substantially from the following sensors: a wheel velocity sensor 39 as to each wheel, the sensor detecting the revolution speed of each wheel 3R, 3L, 5R, or 5L; a yaw angular velocity sensor 41 that detects the actual yaw angular velocity of the vehicle 1; and a steering wheel angle detector 45 that detects the angular displacements as to the steering wheel 43.

In order to stabilize the behavior of the vehicle during cornering, the braking pressure into each wheel cylinder 7 is regulated by means of controlling switchover operation as to the pressure control valves 17 and the air charge valves 33; as a result, the braking force that is generated on each wheel 3R, 3L, 5R, or 5L is controlled.

A yawing control in the present invention is defined as a manner in which the vehicle is given a cornering moment so as to increase the turning ability of the vehicle, or is given a restoring moment so as to restore the cornering condition into a straight-ahead movement; whereby, the cornering or restoring moment can be yielded by means of granting braking force differences between a right wheel and a left wheel during a turning movement, for instance, between the left front wheel 3L and the right rear wheel 5R (during a right turn), or between the right front wheel 3R and the left rear wheel 5L (during a left turn). Thus, it is intended that an actual yawing movement of the vehicle 1 corresponds with a target yawing movement. It is hereby noted that the two wheels to be controlled are not inevitably the pair of the wheels 3L and 5R, or the wheels 3R and 5L in a diagonal position; the pair of two wheels may be a pair of the right and left front wheels 3R and 3L, or a pair of the right and left rear wheels 5R and 5L.

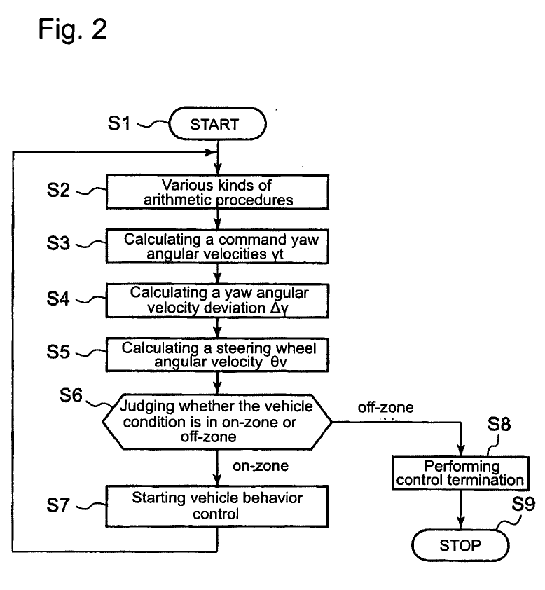

Next, with the flowchart in FIG. 2, a whole streamline for the vehicle behavior control of the control means 37 will be explained.

At first, the control is started with Step S1 then, in Step S2, various kinds of arithmetic procedures are executed, specifically with signals from the wheel velocity sensors 39 for the wheels, are calculated the vehicle running conditions such as a vehicle speed V, an acceleration a thereof, a slip ratio for each wheel. Further, based on a signal from the steering wheel angle detector 45, a steering wheel angular θ displacement is calculated; moreover, based on a signal from the yaw angular velocity sensor 41, an actual yaw angular velocity γ is calculated.

In next Step S3, with a command yaw angular velocity calculation means 50, command yaw angular velocities are computed according to the following formula (3):

γₜ=V/(1+A·V²)·(d/L) (3),

where A and L are a stability factor and a wheel base respectively; and, d is an actual steering wheel angular displacement as to the front wheels that is calculated by means of dividing a steering wheel angular displacement θ by the steering gear ratio ρ.

In the following Step S4, with a yaw angular velocity deviation calculation means 51, a yaw angular velocity deviation Δγ=γₜ−γ_{f} is computed, whereby the yaw angular velocity deviation Δγ means a difference between the command yaw angular velocity γₜ and the actual yaw angular velocity γ_{f} that is calculated based on a signal from the yaw angular velocity sensor 41.

In Step S5 after S4, with a steering wheel angular velocity calculation means 52, is computed a steering wheel angular velocity θv that is obtained by means of differentiating a steering wheel angular displacement θ with respect to time. With reference to this steering wheel angular velocity θv, the transient change of the yaw angular velocity deviation Δγ is predicted.

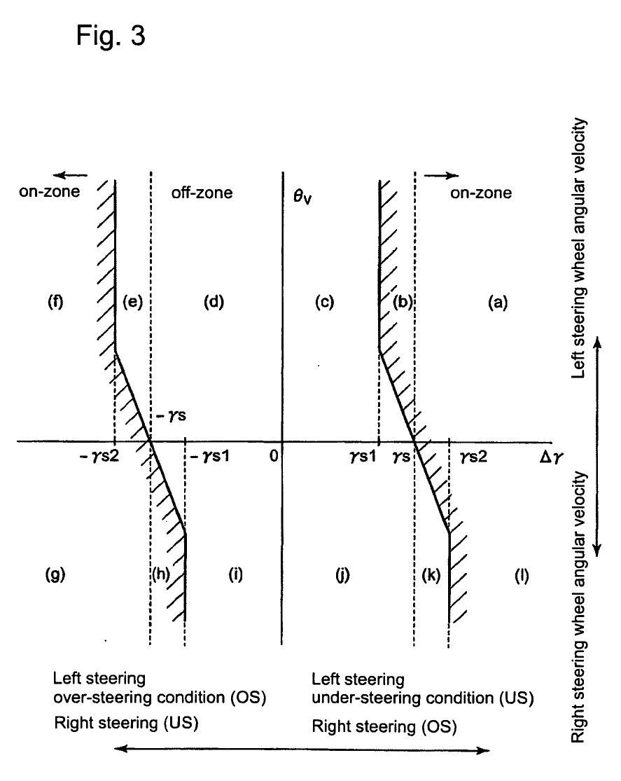

In the following Step S6, with a control start decision means 38, it is judged whether the vehicle behavior condition is in a zone in which the vehicle behavior should be controlled or not. This judgment is performed according to a 2-dimensional threshold map depicted in FIG. 3 where the abscissa and the ordinate denote the yaw angular velocity deviation Δγ and the steering wheel angular velocity θv respectively. Further, in the threshold map, is depicted where is the on- and off-zone as to the vehicle behavior control; based on the map, the control start decision means 38 judges whether the control action should be on or off.

More particularly, the control-start decision means 38 judges not only when the control should be started, namely, when an off-control state is changed into an on-control state, but also when the control should be stopped, namely, when the on-control state is changed into an off-control state.

The on-control state in the threshold map of FIG. 3 is indicated by shaded zone, on-zone, shown therein; that is, the control-start decision means judges that the control should be started when a coordinate of the steering wheel angular velocity θv obtained in Step S5 and the yaw angular velocity deviation Δγ obtained in Step S4 belongs to the on-zone.

When the coordinate (Δγ, θv) is in the on-zone in FIG. 3, Step S6 of the flowchart of FIG. 2 is led to Step S7 and the vehicle behavior control is turned on whereby the braking force differences are given between wheels so that the yaw angular velocity deviation Δγ can be brought close to zero. In contrast, when the coordinate (Δγ, θv) is in off-zone, i.e. when it is not in the on-zone, in FIG. 3, Step S6 of the flowchart of FIG. 2 is led to Step S8 and procedures of control termination are performed and then the control is stopped in following Step S9. In addition, when the vehicle behavior control is started in Step S7, Step S7 is returned to Step S2 so that the procedures are repeated.

In first and third quadrants of the threshold map in FIG. 3, the on-zone is set as a region where abs (Δγ) is greater than abs (γₛ1) in case when abs (θv) is large enough, whereby γₛ1 is a pertinent positive number smaller than a standard threshold value γₛ. In second and fourth quadrants, the on-zone is set as a region where abs (Δγ) is greater than abs (γₛ2) in case when abs (θv) is large enough, whereby γₛ2 is a pertinent positive number greater than the standard threshold value γₛ.

Moreover, the vertical line Δγ=γₛ1 in the first quadrant and the vertical line Δγ=γₛ2 in the forth quadrant are connected with an oblique straight line going through the point γₛ. In a similar manner, the vertical line Δγ=−γₛ2 in the second quadrant and the vertical line Δγ=−γₛ1 in the third quadrant are connected with an oblique straight line going through the point γₛ. In addition, the mentioned slope is determined by experiments in advance.

By setting two threshold lines as stated above, in a zone (b) of the first quadrant, a relation Δγ<γₛ is held and Δγ dose not reach the standard threshold value Ys, but in case of a left turn steering, as the yaw angular velocity deviation Δγ is positive, the vehicle is under an under-steering condition. Furthermore, since the steering wheel angular velocity θv is positive and this velocity θv is prone to increase the yaw angular velocity deviation Δγ, a further increase of the yaw angular velocity deviation Δγ can be estimated, and thus, by starting the vehicle behavior control from early on, lapsing into a strong under-steering condition can be evaded.

Similarly, in a zone (h) of the third quadrant, a relation abs (Δγ)<abs(−γₛ) is held and Δγ dose not reach the standard threshold value (−γₛ). However, in case of a left turn steering, as the yaw angular velocity deviation Δγ is negative, the vehicle is under an over-steering condition. Moreover, since the steering wheel angular velocity θv is negative and this velocity θv is prone to decrease the yaw angular velocity deviation Δγ, a further decrease of the yaw angular velocity deviation Δγ can be estimated, and thus, by starting the vehicle behavior control from early on, lapsing into a strong over-steering condition can be evaded.

Further, in a zone (k) of the fourth quadrant, a relation Δγ>γₛ his held and Δγ is greater than a standard threshold value γₛ. However, in case of a left turn steering, as the yaw angular velocity deviation Δγ is positive, the vehicle is under an under-steering condition. Since the steering wheel angular velocity θv is negative and this velocity θv is prone to decrease the yaw angular velocity deviation Δγ, in the zone (k), the vehicle behavior control is not performed.

Similarly, in a zone (e) of the second quadrant, a relation abs (Δγ)>abs (−γₛ) is held and abs (Δγ) is greater than a standard threshold value (−γₛ). However, in case of a left turn steering, as the yaw angular velocity deviation Δγ is negative, the vehicle is under an over-steering condition; hereby, the steering wheel angular velocity θv is positive and this velocity θv is prone to decrease the yaw angular velocity deviation abs (Δγ). Therefore, in the zone (e), the vehicle behavior control is not performed.

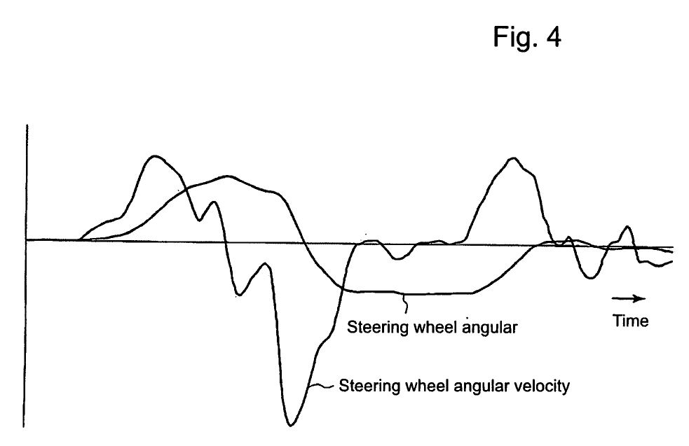

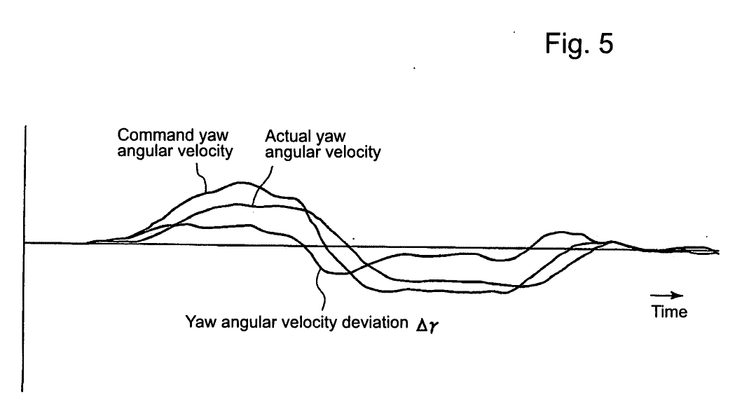

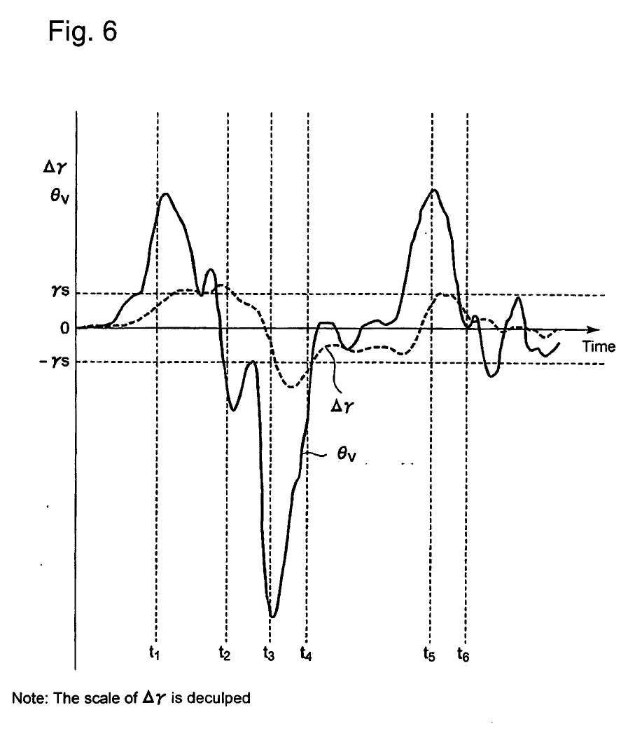

In FIGS. 4 to 6, is shown the behavior of a vehicle without the vehicle behavior control device, the vehicle turning into the left lane on a low-friction road such as a snowy road. FIG. 4 shows a time-history state as to a steering wheel angular displacement θ and the steering wheel angular velocity θv. FIG. 5 shows changes in an actual yaw angular velocity, a command yaw angular velocity, and a yaw angular velocity deviation Δγ; FIG. 6 shows the time-history state as to the yaw angular velocity deviation Δγ that is excerpted from the data in FIG. 5, together with the steering wheel angular velocity θv that is excerpted from the data in FIG. 4.

In FIG. 4, the abscissa denotes a time parameter and the ordinate denotes the steering wheel angular displacement θ and the steering wheel angular velocity θv; in FIG. 5, the abscissa denotes time and the ordinate denotes the actual yaw angular velocity, the command yaw angular velocity, and the yaw angular velocity deviation Δγ; in FIG. 5, are described the threshold lines as to the standard threshold values +γₛ and −γₛ in relation to an ordinate parameter Δγ, namely, the yaw angular velocity deviation.

Further, the following points as to a driver's sense of steering operation can be summed-up from FIG. 6 in connection to the behavior characteristics of the vehicle without automatic yawing control, as stated in Table 1.

TABLE 1

| Elapsed | |
|---|---|
| Time | Vehicle Behavior and Drivers' Feelings |
| t1 | when a driver turns the steering wheel to the |
| | left, a yawing movement to the left occurs |
| | with a phase delay. At the time t1, Δγ is less |
| | than γₛ; yet, as θv is positive, the driver |
| | expects that Δγ becomes greater than γₛ |
| | meanwhile |
| t2 | at the time t2, Δγ is greater than γₛ; yet, |
| | as θv is negative, the driver expects that |
| | Δγ becomes less than or equal to γₛ meanwhile |
| t3 | at the time t3, in a hurry, a driver cut the |
| | steering wheel to the right in order to |
| | reverse the yawing direction. Thereby, |
| | abs(Δγ) is greater than abs(−γₛ); yet, as θv |
| | is negative, the driver expects that abs(Δγ) |
| | becomes less than abs(−γₛ) meanwhile |
| t4 | at the time t4, abs(Δγ) is less than abs(−γₛ); |
| | yet, as θv is small enough, the driver expects |
| | that the transient yawing movement converges |
| | on a normal steering movement |
| t5 | at the time t5, the driver is going to set |
| | the steering wheel in the nutral position, |
| | preparing for the completion of a lane |
| | change. Thereby, Δγ is less than γₛ; yet, as |
| | θv is positive, the driver expects that Δγ |
| | becomes greater than or equal to γₛ meanwhile. |
| | Further, the driver predicts necessary |
| | counter |
| | steering-wheel-angular-displacement to be |
| | held and the time duration thereof |
| t6 | at the time t5, Δγ becomes substantially |
| | equal to γₛ; and, as θv is small enough, the |
| | driver expects that the yawing movement |
| | converges on a linear movement |

From the above table 1, it can be understood that, at the points in time t1, t3 and t5, the Δγ variation is preferably predicted according to the θv value, and switch the vehicle behavior control from OFF to ON so as to ensure steering stability. At the points in time t2, t4 and t6, the vehicle behavior control is preferably switched from ON to OFF so as to secure quick responses and convergence.

Therefore, in the present invention, starting- and stopping-criteria as to the vehicle behavior control is stipulated by the 2-dimensional threshold map, whereby the two dimensions are formed with two parameters of the yaw angular velocity deviation Δγ and the steering wheel angular velocity θv; further, as shown in FIG. 3, in contrast to two simple half-plane zones expressed by formulae Δγ>γₛ and Δγ<γₛ, the on-control zone is enlarged in the first and the third quadrants, while the on-control zone is reduced in the second and the fourth quadrants.

In comparison with a vehicle behavior control based on only a parameter i.e. the yaw angular velocity deviation Δγ, another parameter i.e. the steering wheel angular velocity θv is made reference to the control device according to the present invention; thus, the control starting- and stopping-timings, namely, a timing from control ON-state to OFF-state or vice versa, are optimized so that the steering characteristic according to a driver's intention is faithfully realized.

Furthermore, the adoption of a 2-dimensional map for setting threshold values makes it easier to alter the threshold characteristics.

Still further, when the yaw angular velocity deviation Δγ is chosen as an ordinate parameter in the 2-dimensional map (FIG. 3) for control start- and stop-judgment, then a low-pass filtration process (computing) becomes necessary, as the ordinate parameter has to be differentiated with respect to time and the parameter comprises high frequency components.

Contrarily to the above, in the present invention, the steering wheel angular velocity θv is chosen as the ordinate parameter, and a low-pass filtration process is not needed; as a result, the data processing speed is improved. The reason is that the parameter θv is calculated by means of differentiating a steering wheel angular displacement θ with respect to time and the parameter θ comprises fewer noise components than the parameter Δγ.

1. A vehicle behavior control device for controlling a yawing movement of a vehicle during a circling movement by giving a braking force difference between a right wheel and a left wheel to prescribed wheels, wherein the device comprises:
a wheel velocity detection means;
a steering wheel angular displacement detection means to detect a steering wheel angular displacement;
a yaw angular velocity detection means to detect an actual yaw angular velocity;
a command yaw angular velocity calculation means to calculate a command yaw angular velocity based upon a wheel velocity retrieved by the wheel velocity detection means and a steering wheel angular displacement retrieved by the steering wheel angular displacement detection means;
a yaw angular velocity deviation calculation means to calculate a yaw angular velocity deviation between a command yaw angular velocity calculated by the command yaw angular velocity calculation means and an actual yaw angular velocity detected by the yaw angular velocity detection means;
a steering evaluation means to estimate whether the yaw angular velocity deviation is on the increase or on the decrease;
a control start decision means to determine whether a control as to the braking force difference between the wheels is started or not when the yaw angular velocity deviation calculated by the yaw angular velocity deviation calculation means pass a prescribed threshold;
whereby, the prescribed threshold is altered when it is estimated by the steering evaluation means, whether the yaw angular velocity deviation is on the increase or on the decrease

2. A vehicle behavior control device according to claim 1, wherein the threshold is altered so that an absolute value of the threshold is made smaller than that of a prescribed threshold as a standard, when it is estimated that the yaw angular velocity deviation calculated by the yaw angular velocity deviation calculation means is on the increase.

3. A vehicle behavior control device according to claim 1, wherein the threshold is altered so that the absolute value of the threshold is made greater than that of a prescribed threshold as a standard, in case when it is estimated that the yaw angular velocity deviation calculated by the yaw angular velocity deviation calculation means is on the decrease.

4. A vehicle behavior control device according to claim 1, the device further comprising a steering wheel angular velocity calculation means to calculate a steering wheel angular velocity that is a time differentiation of the steering wheel angular displacement,
wherein the steering evaluation means estimates whether the yaw angular velocity deviation is on the increase or on the decrease based upon a steering wheel angular velocity calculated by the steering wheel angular velocity calculation means.

5. A vehicle behavior control device according to claim 1, the device further comprising a yaw angular acceleration deviation calculating means to calculate a yaw angular acceleration deviation that is a time differentiation of a yaw angular velocity deviation computed by means of the yaw angular velocity deviation calculation means,
wherein the steering evaluation means estimates whether the yaw angular acceleration deviation is on the increase or on the decrease, based upon a yaw angular acceleration deviation calculated by the yaw angular acceleration deviation calculating means.

6. A vehicle behavior control device according to claim 4, whereby the control start decision means comprises a 2-dimensional threshold map as to a yaw angular velocity deviation and a steering wheel angular velocity, wherein a threshold as to the control start is configured in the 2-dimensional threshold map.

7. A vehicle behavior control device according to claim 5, whereby the control start decision means comprises a 2-dimensional threshold map as to a yaw angular velocity deviation and a yaw angular acceleration deviation, wherein a threshold as to the control start is described in the 2-dimensional threshold map.
